(19) United States
(12) Patent Application Publication
(10) Pub. No.: US 2011/0281189 A1
(43) Pub. Date: Nov. 17, 2011

(54) CONNECTION STRUCTURE BETWEEN OXIDIZER AND FUEL VAPORIZER IN FUEL REFORMER AND METHOD FOR FORMING THE SAME

(75) Inventors: Jong-Rock Choi, Yongin-si (KR); In-Hyuk Son, Yongin-si (KR); Jin-Goo Ahn, Yongin-si (KR); Woo-Cheol Shin, Yongin-si (KR); In-Seob Song, Yongin-si (KR)

(73) Assignee: Samsung SDI Co., Ltd., Yongin-si (KR)

(21) Appl. No.: 12/912,495

(22) Filed: Oct. 26, 2010

(30) Foreign Application Priority Data
May 14, 2010 (KR) 10-2010-0045251

(51) Int. Cl. H01M 8/06; B23P 11/00

(52) U.S. Cl. 429/423; 29/428; 429/535

(57) ABSTRACT

A connection structure between a fuel vaporizer and an oxidizer in a fuel reformer is disclosed. Fuel reformers having the connection structure may be included in fuel cell systems. Methods for forming the connection structure are also disclosed. The method includes forming the fuel vaporizer and forming the oxidizer. Forming the fuel vaporizer may include forming through-holes in a bottom panel and a top panel to form the fuel vaporizer, forming an inner side panel protruding in a direction substantially normal to a frame of the bottom panel through-hole and welding a top portion of the inner side panel to the frame of the top panel through-hole. Forming the oxidizer may include welding a top portion of an inner wall of the oxidizer to a bottom surface of the frame of the bottom panel through-hole.

### CROSS-REFERENCE TO RELATED APPLICATIONS

This application claims priority to and the benefit of Korean Patent Application No. 10-2010-0045251, filed on May 14, 2010, in the Korean Intellectual Property Office, the entire content of which is incorporated herein by reference.

### BACKGROUND

1. Field

The present disclosure is related to a connection structure between an oxidizer and a vaporizer, which may be used in a fuel reformer of a fuel cell system.

2. Description of the Related Art

As concern about the exhaustion of carbon energy and interest in environmental pollution have increased, attempts have been made to develop non-polluting electric energy. Particularly, studies have been conducted to develop a fuel cell that generates electric energy from materials such as hydrogen and oxygen. Primarily because of various problems related to storage of Hydrogen gas (H₂), H₂ used as a fuel of the fuel cell is generally produced as a reformate obtained by reforming ethanol, methanol, liquefied petroleum gas (LPG) or gasoline. A fuel reformer includes a reforming reactor that reforms an original fuel to generate a mixture gas containing abundant hydrogen. In operation, the process for generating reformate includes a steam reforming method, an autothermal reforming method and a partial oxidation method.

A fuel vaporizer and an evaporator may be provided in the fuel reformer to improve fuel efficiency and device performance. The fuel vaporizer functions to prevent reaction inequality in the reforming reactor by vaporizing moisture in an original liquid fuel flowing into the reforming reactor. The evaporator functions to evaporate the original liquid fuel and to supply the evaporated fuel to the fuel reformer. It is not uncommon for cracks to occur at a welding connection between the fuel vaporizer and the evaporator. Cracks inevitably create leakage and resulting device inefficiencies.

### SUMMARY OF CERTAIN INVENTIVE ASPECTS

In one aspect, there is provided a connection structure between an oxidizer and a fuel vaporizer in a fuel reformer with improved integrity and stability.

In another aspect, a method of making a connection structure between a fuel vaporizer and a fuel reformer is provided that has improved welding efficiency and improved integrity and stability during a secondary welding process.

In another aspect, a connection structure between a fuel vaporizer and an oxidizer, which constitute a fuel reformer in a fuel cell system, is provided. In some embodiments, the fuel vaporizer may include, for example, a bottom panel having a first through-hole formed therein, an inner side panel protruded in a direction substantially normal to an inner frame surface of the first through-hole, and a top panel having a second through-hole positioned to be in fluid communication with the first through-hole, wherein the top panel is also positioned for connection to a top portion of the inner side panel through a primary weld. In some embodiments, the oxidizer may include, for example, a third through-hole to be in fluid communication with the first through-hole and the second through-hole, and a top portion of an inner wall positioned for connection to the bottom panel of the fuel vaporizer through a secondary weld.

In some embodiments, the primary weld includes, for example, a weld of a joint portion between an inner frame surface of the second through-hole and of the top portion of the inner side panel, and wherein the secondary weld includes, for example, a weld of a joint portion between the bottom surface of the frame of the first through-hole of the bottom panel and the top surface of the inner wall of the oxidizer. In some embodiments, the primary weld includes, for example, a weld of a joint portion between the bottom surface of the frame of the first through-hole of the top panel and the top surface of the inner side panel. In some embodiments, the inner side panel of the fuel vaporizer includes a burred edge. In some embodiments, the bottom panel is formed with a thickness greater than about 0.6 mm. In some embodiments, the bottom panel and the inner side panel are each formed with a thickness of equal to or greater than about 1 mm.

In another aspect, a method for connecting a fuel vaporizer and an oxidizer of a fuel reformer in a fuel cell system, the method may include, for example, forming a fuel vaporizer and forming an oxidizer connected to the fuel vaporizer. In some embodiments, forming the fuel vaporizer includes, for example, forming through-holes in a bottom panel and a top panel, forming an inner side panel protruding in a direction substantially normal to a frame of the bottom panel through-hole, and welding a top portion of the inner side panel to the frame of the top panel through-hole. In some embodiments, forming the oxidizer includes, for example, welding a top portion of an inner wall of the oxidizer to a bottom surface of the frame of the bottom panel through-hole. In some embodiments, forming the inner side panel includes casting, cutting or drilling the through-hole of the bottom panel to create a burred edge.

In another aspect, a fuel reformer of a fuel cell system includes a fuel vaporizer and an oxidizer. In some embodiments, the fuel vaporizer includes, for example, a bottom panel having a first through-hole formed therein, an inner side panel protruded in a direction substantially normal to an inner frame surface of the first through-hole, and a top panel having a second through hole and positioned on the inner side panel configured for connection to a top portion of the inner side panel through a primary weld. In some embodiments, the oxidizer includes, for example, a top portion of an inner wall connected to the bottom panel through a secondary weld.

In some embodiments, the inner side panel of the fuel vaporizer includes, for example, a burred edge, wherein the bottom panel is formed with a thickness greater than about 0.6 mm, and wherein the bottom panel and the inner side panel are each formed with a thickness of equal to or greater than about 1 mm. In some embodiments, the second through-hole is in fluid communication with the first through-hole of the bottom panel, wherein the primary weld includes, for example, a weld of a joint portion between an inner frame surface of the second through-hole and an upper inner surface of the inner side panel, and wherein the secondary weld includes, for example, a weld of a joint portion between the bottom surface of the frame of the first through-hole of the bottom panel and the top surface of the inner wall of the oxidizer. In some embodiments, the second through-hole is in fluid communication with the first through-hole of the bottom panel, and the primary weld includes, for example, a weld of a joint portion between the bottom surface of the frame of the second through-hole of the top panel and a top surface of the top portion of the inner side panel.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how the illustrated features serve to explain certain principles of the present disclosure.

FIG. 1A is a schematic view showing the installation positions of a fuel vaporizer and an evaporator in a general fuel reformer.

FIG. 1B is a schematic view showing the manufacturing structure of a fuel vaporizer.

FIG. 1C is a schematic view showing a connection structure between the fuel vaporizer of FIG. 1B and an oxidizer.

FIG. 2A is a partial enlarged view of one embodiment of a fuel reformer.

FIG. 2B is a schematic view depicting a connection structure between a fuel vaporizer and an oxidizer in the fuel reformer.

FIGS. 3A and 3C are schematic views illustrating a process of forming an inner side panel.

FIG. 4 is a schematic view showing a connection structure between the inner side panel and a top panel.

FIG. 5 is a schematic view showing a modification of the connection structure between the inner side panel and the top panel.

FIG. 6 is a flowchart illustrating a connection method between the fuel vaporizer and the oxidizer.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when a particular feature is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. Certain embodiments will be described in more detail with reference to the accompanying drawings, so that a person having ordinary skill in the art can readily make and use aspects of the present disclosure.

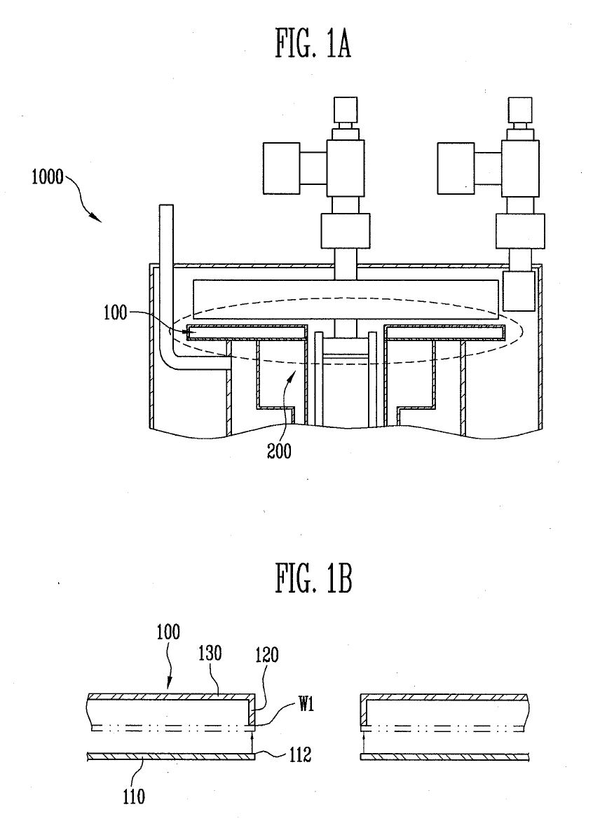

FIG. 1A is a partial enlarged sectional view of a fuel reformer 1000. As depicted in FIG. 1A, a fuel vaporizer 100 and an oxidizer 200 are vertically connected to each other through welding in one unit.

FIG. 1B is a schematic view showing the manufacturing structure of a fuel vaporizer and FIG. 1C is a schematic view depicting a connection structure between the fuel vaporizer of FIG. 1B and an oxidizer. As illustrated in FIGS. 1B and 1C, a primary welding portion W1 is positioned in the fuel oxidizer 100. The primary welding portion W1 is positioned where a primary welding process is performed during the manufacturing process of the fuel oxidizer 100. The primary welding portion W1 also overlaps a secondary welding portion W2 of the fuel oxidizer 100. The secondary welding portion W2 represents is positioned where a secondary welding process is performed in the process of connection between the fuel vaporizer 100 and the oxidizer 200. When the secondary welding process is performed on or near the primary welding portion W1, it is highly likely that a defect may occur in the secondary welding portion W2. Further, when the secondary welding process is performed, it is also likely that cracks form the primary welding portion W1. These cracks and defects create leakage problems in the fuel vaporizer 100.

As depicted in FIGS. 1B and 1C, the fuel vaporizer 100 includes a bottom panel 110, an inner side panel 120 and a top panel 130. Here, the inner side panel 120 is formed extending from a frame of a first through-hole formed in the top panel 130. A bottom portion of the inner side panel 120 is connected to a frame of a second through-hole formed in the bottom panel 110. The connection between the bottom portion of the inner side panel 120 and the bottom panel 110 is made through the primary welding process during manufacturing the fuel vaporizer 100. FIG. 1B illustrates the eventual connection between the bottom portion of the inner side panel 120 and the bottom panel 110 with an arrow.

The connection between the fuel vaporizer 100 and the oxidizer 200 is depicted in FIG. 1C. The process of connecting the fuel vaporizer 100 and the oxidizer 200 is performed by joining the top portion of a side wall 210 of the oxidizer 200 on the frame of the second through-hole 112 of the bottom panel 110 at the primary welding portion W1 and then performing the secondary process with respect to the primary welding portion W1.

As described above, because of the manufacturing of the fuel vaporizer structure of the fuel vaporizer 100, the position of the primary welding portion W1 overlaps with the position of the secondary welding portion W2. As indicated above, the primary welding portion W1 indicates the area where the primary welding process is performed during manufacture of the fuel vaporizer 100 and the secondary welding portion W2 indicates the area where the secondary welding process is performed in the connection process between the fuel vaporizer 100 and the oxidizer 200.

Meanwhile, the inner side panel 120 of the fuel vaporizer 100 is formed by a burring process with respect to the first through-hole of the top panel 130. The burring process comprises casting, cutting or drilling the first through-hole of the top panel 130 to create a burred edge and the inner side panel 120 illustrated in FIG. 1C. The burring process results in the phenomenon that the strength of a flange extended from the first through-hole, (for example, the strength of the inner side panel 120) may be decreased because of its characteristics.

However, in the manufacturing process of the fuel vaporizer, the top panel 130 is formed to have a thickness of about 0.6 mm. During use, as described above, the top panel 130 has such a thin thickness that an end portion of the inner side panel may decrease in strength and may be easily cracked. When primary and secondary welding processes are performed and the end portion of the inner side panel is cracked, the corresponding portion (W1 or W2 respectively) is broken by welding heat. Thus, this problem was identified during the process of studying fuel cell reformers. Some aspects of the present disclosure relate to solving these identified problems.

Hereinafter, the configuration and operation of another embodiment of a connection structure will be described in detail with reference to the accompanying drawings.

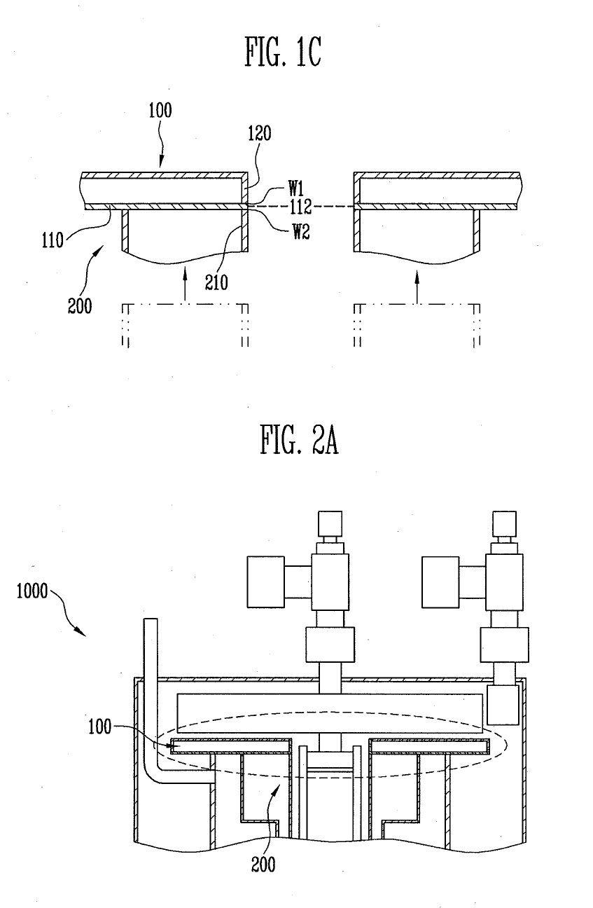

FIG. 2A is a partial enlarged sectional view of a fuel reformer. FIG. 2A differs from FIG. 1A in the connection structure between a fuel vaporizer and an oxidizer, which is discussed further below and illustrated in FIG. 2B. FIG. 2B is an enlarged view showing a connection structure between a fuel vaporizer and an oxidizer in the fuel reformer. As depicted in these figures, the fuel vaporizer 100 and the oxidizer 200 have a structure in which they are vertically connected to each other about a bottom panel 110 of the fuel vaporizer 100.

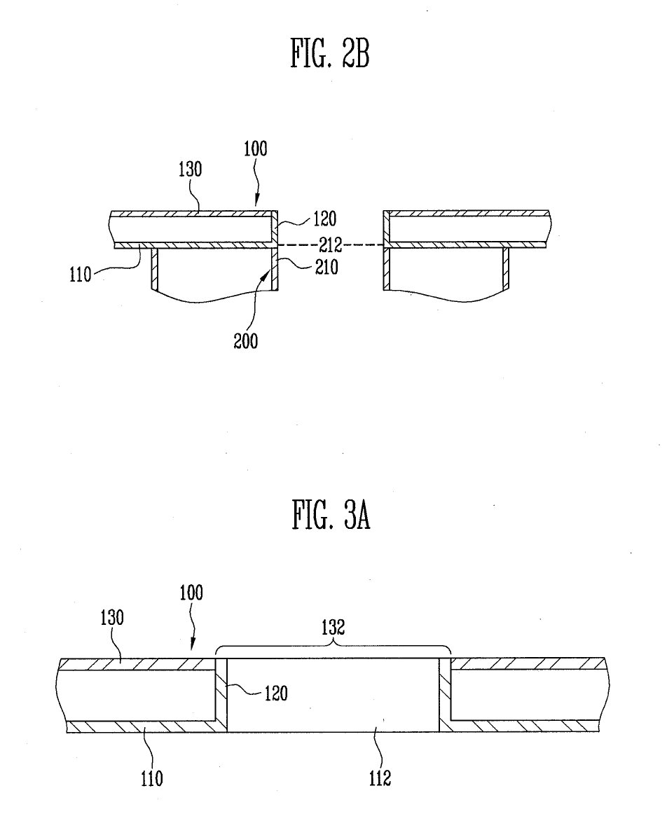

As depicted in FIG. 3A, the fuel vaporizer 100 includes a bottom panel 110, an inner side panel 120 and a top panel 130, and a space portion 140 formed in the interior of the fuel vaporizer 100. The bottom panel 100 is a portion that serves as a bottom surface of the fuel vaporizer 100 and serves as a connection portion with the oxidizer 200, which will be described later. The bottom panel 100 is formed in the shape of a circular or prismatic plate. A first through-hole 112 is formed at the center of the bottom panel 100. The first through-hole 112 serves as a path of a combustion gas in the fuel reformer. The inner side panel 120 is formed on a frame of the first through-hole 112. Here, the inner side panel 120 forms a connection between the bottom panel 110 and the top panel 130, which will be described later. The inner side panel 120 has the shape of a cylindrical tube extended upward from the frame of the first through-hole 112, which will be described later.

The inner side panel 120 is formed through a burring process. The burring process will be briefly described. As depicted in FIG. 3B, the first through-hole 112 is first formed in the bottom panel 110 through a punching process or the like. In this state, if a tool 300 with a diameter greater than that of the first through-hole 112 passes through the first through-hole 112 from bottom to top as depicted in FIG. 3C, the entire frame of the first through-hole 112 is simultaneously pushed up by the tool 300, so that the inner side panel 120 may be formed. In this case, the strength of a portion pushed and protruded from the first through-hole 112 in the burring process, for example, the strength of a portion corresponding to the inner side panel 120 is decreased as described above. Particularly, portions of the inner side panel 120, which are furthest from the bottom panel 110 are those portions of the inner side panel 120 which are most weakened by this process.

When the inner side panel is formed from the top panel (for example, in FIGS. 1B and 1C), the thickness of the top panel is about 0.6 mm. In this case, the burring process may be performed with respect to the top panel with the aforementioned thickness. However, the end portion of the inner side panel may crack because of characteristics of the burring process as described above.

Accordingly, in some embodiments, the thickness of the bottom panel 110 having the inner side panel 110 formed therefrom is applied to about 1 mm thicker than about 0.6 mm. As proved by experimental result, in performing a burring process with respect to the bottom panel 110 with a thickness of 1 mm or thicker, the end portion of the inner side panel 120 is not cracked. Thus, as the thickness of the bottom panel 110 is increased, the durability of the inner side panel 120 is improved. However, because the thickness of the bottom panel 110 is increased, the force applied in the burring process also should be increased. Further, when the force applied in the burring process is increased, working efficiency is decreased. In some embodiments when the thickness of the bottom panel 110 is a minimum of about 1 mm, an optimal durability and working efficiency can be obtained.

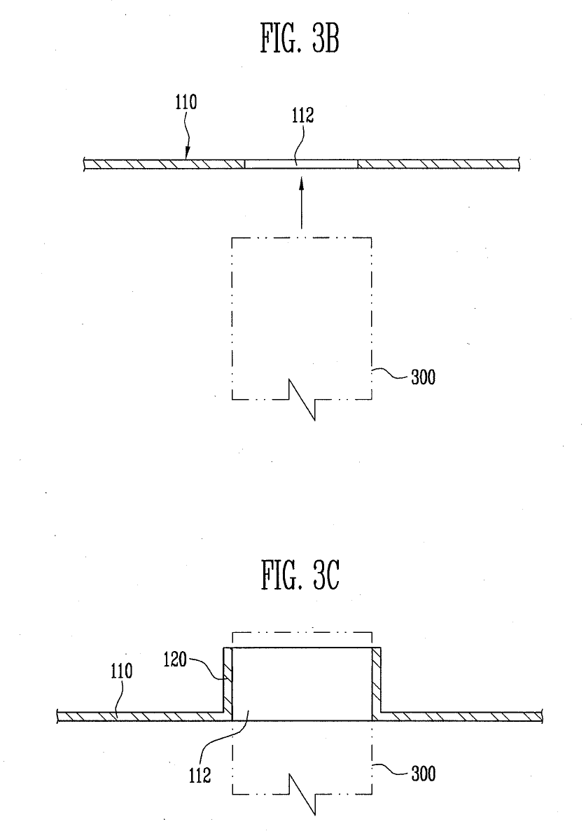

As depicted in FIG. 4, a top panel 130 that serves as a ceiling of the fuel vaporizer 100 is provided above the bottom panel 110. The bottom panel 110 has the inner side panel 120 formed therefrom. The top panel 130 is formed in the shape of a plate having the same form and area as the bottom panel 110. The top panel 130 is positioned on the top portion of the inner side panel 120. The top panel 130 includes a second through-hole 132, which is formed at the center of the top panel 130 and positioned with respect to the first through-hole 112 of the bottom panel 110. In this state, as depicted in FIG. 4, an upper outer circumferential surface of the inner side panel 120 is joined with an inner circumferential surface of the second through-hole 132 of the top panel 130. A primary welding process is performed with respect to the joint portion of the upper outer circumferential surface of the inner side panel 120 and the inner circumferential surface of the second through-hole 132. Accordingly, the top panel 130 and the bottom panel 110 are connected to each other by means of the inner side panel 120, as illustrated in the completed fuel vaporizer 100 in FIG. 3A.

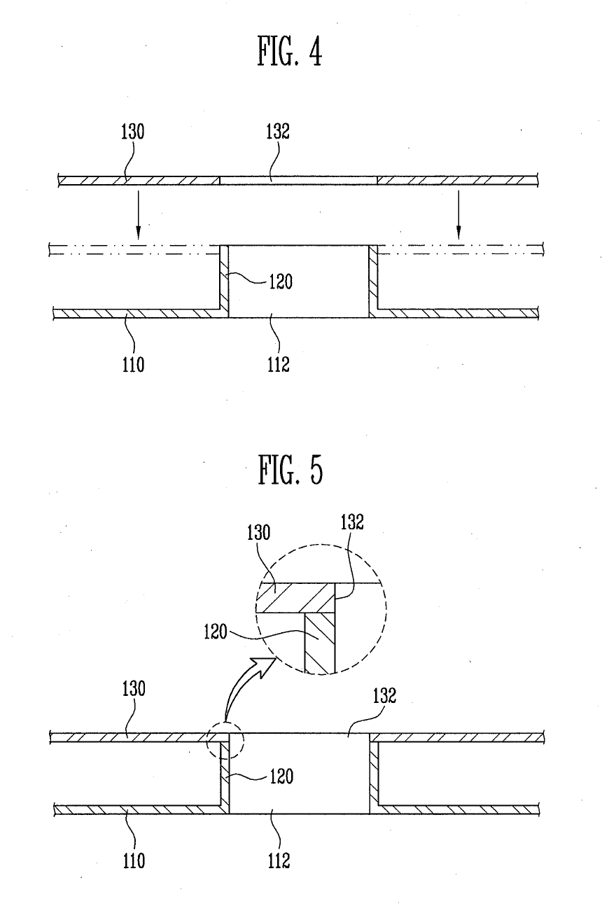

For reference, the joint structure between the top panel 130 and the inner side panel 120 may have a structure in which the top panel 130 is connected to the inner side panel 120 by inserting the top portion of the inner side panel 120 into the second through-hole 132 of the top panel 130 as described above. In addition, the joint structure between the top panel 130 and the inner side panel 120 may also be modified as a structure in which the top portion of the inner side panel 120 is joined with a bottom surface of the frame of the second through-hole 132 as depicted in FIG. 5.

As depicted in FIG. 2B, the oxidizer 200 is connected to the bottom of the fuel vaporizer 100 completed as described above. The oxidizer 200 entirely has the shape of a double tube as known in the art. However, for convenience of illustration, only an inner tube (hereinafter, referred to as an “inner wall 210”) is depicted in this figure.

A third through-hole 212 is formed in the interior of the inner wall 210. The third through-hole 212 is formed to communicate with the first and second through-holes 112 and 132 of the fuel vaporizer 100.

In this case, a top surface of the inner wall 210 in the oxidizer 200 is joined with the bottom surface of the frame of the first through-hole 112 of the bottom panel 110 in the fuel vaporizer 100, and a secondary welding process is performed with respect to the corresponding joint portion. Accordingly, the connection between the fuel vaporizer 100 and the oxidizer 200 is formed.

As described above, some embodiments of the present disclosure are different from the fuel vaporizers depicted in FIGS. 1B and 1C in that, in the process of manufacturing the fuel vaporizer 100, the inner side panel 120 is not formed from the top panel 130, but instead is formed from the bottom panel 110 so that a primary welding portion W1 is formed at the joint portion between the inner side panel 120 and the top panel 130. Thus, the primary welding process is performed during the process of manufacturing the fuel vaporizer 100 at the primary welding portion W1. The position of the primary welding portion W1 does not overlap with the position of a secondary welding portion W2. The secondary welding portion W2 identifies the area where a secondary welding process is performed during the connection process between the fuel vaporizer 100 and the oxidizer 100. As the primary and secondary welding portions W1 and W2 are formed separately from each other, both in location in the reformer and in time, it is possible to prevent cracks from occurring. For example, during manufacturing, it is possible to prevent cracks from forming at the primary welding portion W1 during the process of performing the secondary welding process. As it is possible to prevent the cracks of the primary welding portion W1 that function to seal the fuel vaporizer 100, it is also possible to prevent the leakage phenomenon of the fuel vaporizer 100.

Further, the efficiency of the secondary welding process can be improved because the secondary welding process is not performed at the primary welding portion W1, but instead the secondary welding process is performed with respect to a different portion of the reformer. Thus, the secondary welding process is performed to improve the connection between the fuel vaporizer 100 and the oxidizer 200.

As described above, the thickness of the bottom panel 110 having the inner side panel 120 formed therefrom is approximately 1 mm thicker than that used in the fuel vaporizer depicted in FIGS. 1B and 1C. This thickness of the bottom panel 110 and the inner side panel 120 prevent the top portion of the inner side panel 120 from cracking due to the decrease in the strength of the inner side panel 120 during the burring process. Thus, since the primary welding process is performed directly on the top portion of the inner side panel 120, it is possible to prevent the top portion of the inner side panel 120 from being broken during the primary welding process.

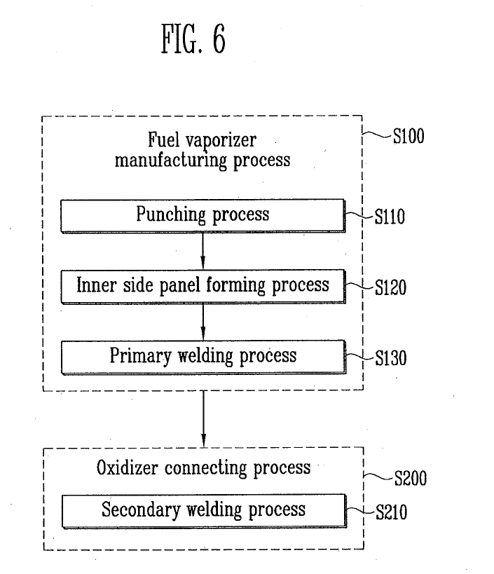

A connection method between the fuel vaporizer 100 and the oxidizer 200 will be described based on the connection structure between the fuel vaporizer 100 and the oxidizer 200. As depicted in FIG. 6, the connection method is divided into a fuel vaporizer manufacturing process (S100) and an oxidizer connecting process (S200). The fuel vaporizer manufacturing process (S100) includes, for example, a punching process (S110), an inner side panel forming process (S120) and a primary welding process (S130). In the punching process (S110), the first and second through-holes 112 and 132 are formed in the top panel 130 and the bottom panel 110, respectively. In the inner side panel forming process (S120), the inner side panel 120 is formed on the frame of the first through-hole 112 of the bottom panel 110 through the burring process. In the primary welding process, the top portion of the inner side panel 120 is connected to the frame of the second through-hole 132 of the top panel 130. The oxidizer connecting process (S200) includes, for example, a secondary welding process (S210), in which the top portion of the inner wall 210 that constitutes the oxidizer is connected to the bottom surface of the frame of the first through-hole 112 in the bottom panel 110.

Through the above-described connection methods, the fuel vaporizer is manufactured and the oxidizer is connected to the fuel vaporizer, so that the primary and secondary welding portions W1 and W2 are separate from each other as they undergo the primary and secondary welding processes, respectively.

Various features of the disclosure described above may be modified and combined by those skilled in the art. However, the modification and combination provide a connection method in which a fuel vaporizer is manufactured by performing a primary welding process with respect to a joint portion between a top portion of an inner side panel and a top panel in the state that the inner side panel is extended upward from a bottom panel, and the fuel vaporizer and an oxidizer are connected to each other by performing a secondary welding process with respect to a joint portion between the top portion of an inner wall of the oxidizer and the bottom panel, so that the positions of primary and secondary welding portions are formed different from each other. Therefore, when the modification and combination are related to the configuration and object in which it is possible to prevent the primary welding portion from being broken due to the overlapping of the primary and secondary welding portions, they may be included in the protection scope of the present disclosure.

While the present disclosure has been described in connection with certain exemplary embodiments, it will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A connection structure between a fuel vaporizer and an oxidizer, which constitute a fuel reformer in a fuel cell system, comprising:
the fuel vaporizer comprising a bottom panel having a first through-hole formed therein, an inner side panel protruded in a direction substantially normal to an inner frame surface of the first through-hole, and a top panel having a second through-hole positioned to be in fluid communication with the first through-hole, wherein the top panel is also positioned for connection to a top portion of the inner side panel through a primary weld; and
the oxidizer comprising a third through-hole to be in fluid communication with the first through-hole and the second through-hole, and a top portion of an inner wall positioned for connection to the bottom panel of the fuel vaporizer through a secondary weld.

2. The connection structure of claim 1, wherein the inner side panel of the fuel vaporizer comprises a burred edge.

3. The connection structure of claim 2, wherein the bottom panel is formed with a thickness greater than about 0.6 mm.

4. The connection structure of claim 3, wherein the bottom panel and the inner side panel are each formed with a thickness of equal to or greater than about 1 mm.

5. The connection structure of claim 1, wherein the primary weld comprises a weld of a joint portion between an inner frame surface of the second through-hole and of the top portion of the inner side panel, and wherein the secondary weld comprises a weld of a joint portion between the bottom surface of the frame of the first through-hole of the bottom panel and the top surface of the inner wall of the oxidizer.

6. The connection structure of claim 5, wherein the inner side panel of the fuel vaporizer comprises a burred edge.

7. The connection structure of claim 6, wherein the bottom panel is formed with a thickness greater than about 0.6 mm.

8. The connection structure of claim 7, wherein the bottom panel and the inner side panel are each formed with a thickness of equal to or greater than about 1 mm.

9. The connection structure of claim 1, wherein the primary weld comprises a weld of a joint portion between the bottom surface of the frame of the first through-hole of the top panel and the top surface of the inner side panel.

10. The connection structure of claim 9, wherein the inner side panel of the fuel vaporizer comprises a burred edge.

11. The connection structure of claim 10, wherein the bottom panel is formed with a thickness greater than about 0.6 mm.

12. The connection structure of claim 11, wherein the bottom panel and the inner side panel are each formed with a thickness of equal to or greater than about 1 mm.

13. A method for connecting a fuel vaporizer and an oxidizer of a fuel reformer in a fuel cell system, the method comprising:
forming a fuel vaporizer; and
forming an oxidizer connected to the fuel vaporizer,
wherein forming the fuel vaporizer comprises forming through-holes in a bottom panel and a top panel, forming an inner side panel protruding in a direction substantially normal to a frame of the bottom panel through-hole, and welding a top portion of the inner side panel to the frame of the top panel through-hole, and
wherein forming the oxidizer comprises welding a top portion of an inner wall of the oxidizer to a bottom surface of the frame of the bottom panel through-hole.

14. The connection method of claim 13, wherein forming the inner side panel comprises casting, cutting or drilling the through-hole of the bottom panel to create a burred edge.
